(19) United States
(12) Patent Application Publication
(10) Pub. No.: US 2012/0081703 A1
(43) Pub. Date: Apr. 5, 2012

(54) Highly Efficient Plamonic Devices, Molecule Detection Systems, and Methods of Making the Same

(75) Inventors: Martin Moskovits, Santa Barbara, CA (US); Xuegong Deng, Piscataway, NJ (US); Thomas Wray Tombler, JR., Somerset, NJ (US); Gary Bernard Braun, Santa Barbara, CA (US); Paul Frank Sciortino, JR., Bridgewater, NJ (US)

(73) Assignee: NANT HOLDINGS IP, LLC, Los Angeles, CA (US)

(21) Appl. No.: 13/273,105

(22) Filed: Oct. 13, 2011

Related U.S. Application Data
(63) Continuation-in-part of application No. 12/437,091, filed on May 7, 2009.
(60) Provisional application No. 61/393,022, filed on Oct. 14, 2010.

(51) Int. Cl. G01J 3/44; C25D 5/34; G02B 5/18; C23F 1/04; B82Y 20/00

(52) U.S. Cl. 356/301; 359/566; 216/24; 205/210; 977/932

(57) ABSTRACT

A plasmonic device has a plurality of nanostructures extending from a substrate. Each of the plurality of nanostructures preferably includes a core, a coating of intermediate material covering at least a portion of the core, and a coating of a plasmonic material. Devices are preferably manufactured using lithography to create the cores, and Plasma Enhanced Chemical Vapor Deposition (PECVD) to deposit the intermediate and/or plasmonic materials. Cores can be arranged in any suitable pattern, including one-dimensional or two-dimensional patterns. Devices can be used in airborne analyte detectors, in handheld roadside controlled substance detectors, in genome sequencing device, and in refraction detectors.

This application is a continuation-in-part application of U.S. patent application Ser. No. 12/437091 filed on May 7, 2009, and also claims priority to provisional U.S. Provisional Application No. 61/393022 filed on Oct. 14, 2010, each of which is incorporated by herein by reference in their entirety.

### FIELD OF THE INVENTION

The field of the invention is plasmonics.

### BACKGROUND

Raman spectroscopy is a light scattering effect from a monochromatic light source, usually a laser, where the light impinges upon the molecule(s) of the material under detection and excites one of the phonons into a virtual state. Stokes Raman scattering occurs with the molecule is excited from ground state into an excited state. Anti-Stokes Raman scattering occurs with a molecule that is already in an excited state. Normally the Raman effect is very weak and too weak to be used as a sensitive tool to sense and identify a small number of molecules. However, in the presence of nanostructured metal the effect is routinely enhanced a million- to a billion-fold with optimally nanostructured metal systems. This enhancement of the Raman signal is the basis for the field of SERS—Surface Enhanced Raman Spectroscopy. SERS has the capability to sense the presence of a single molecule and routinely can detect with sensitivity down to hundreds of molecules making SERS one of the most sensitive, routine molecular detection system known.

SERS was discovered some 30 years ago, and in the interim various methods and structures have shown SERS enhancement to varying degrees of magnitude, quality and reliability. Nanoparticles, such as silver nanoparticles, and proximate metal films, e.g. silver or gold, have shown extremely large enhancements. The interstitial locations between these films or nanoparticle dimmers or small clusters are often called “hot spots”, where there is a local SERS enhancement. Such enhancement can be a high as 10¹¹ in the hot spot for structures with dimensions that are accessible to extant fabrication methods and calculations.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Creation of hot spots has been shown in roughened metal surfaces or films, nanoparticles deposited on substrates, protrusions on substrates, nanowire gratings and other methods. Surface plasmons are surface electromagnetic waves that occur at the interface between a metal and a dielectric, and propagate parallel to the metal/dielectric boundary. Because the wave is on the boundary of the metal and the dielectric, these oscillations change with irregularities on the boundary, for example, the adsorption of molecules to the metal surface. When the surface plasmon wave encounters an analyte molecule on the metal/dielectric boundary, the molecule can absorb energy from the plasmon, and re-emit it as light, which is then reflected from the metal film.

One commercially available SERS substrate is Klarite™ substrate developed by Mesophotonics™, and described in a press release in early 2005. The stated enhancement factors are 106 with signal variations of less than 15%. The substrate is made by nanometer scale patterning of gold surface on silicon substrates where the regular arrangement of holes form photonic crystals and give the SERS enhancement effect.

Pyramidal Pits

Perney et al. produced a 2-D array of inverted pyramidal pits using conventional optical lithography, using with anisotropic wet etching of silicon with deposition of 300 nm of gold via RF sputtering, and showed that their 2-D structures produced reproducible SERS signals (“Tuning localized plasmons in nanostructured substrates for surface-enhanced Raman scattering”, Optics Express, 14, 847-857, 2006). This is the basis of the Klarite™ commercial SERS substrate. They stated that the structure confines surface plasmons to the sidewalls and bottom of the pits, and they could use different depths to tune localized Plasmon resonances. Pitch was 2 microns and depth was 0.7-1 micron. Stated enhancement factors are greater than 10⁶.

The corresponding patent for the work by Perney et al. above is U.S. Pat. No. 7,483,130. In that patent entitled “Metal Nano-Void Photonic Crystal For Enhanced Raman Spectroscopy”, Baumberg et al. describes a layer of a first material with an index of refraction and a second material in subregions coated with metallodielectric layer(s). The features can be holes (e.g. cylinders) or inverted pyramidal pits or truncated inverted pyramids. A 2D periodic lattice structure with square, triangular, rectangular lattice geometries can be used. It can be periodic or quasiperiodic, with or without defects. The coating of metal or metallodielectric layer can contain several metal and dielectric films or just one film (e.g. one metal with a thin adhesion layer on top of the dielectric support. It can be a membrane configuration where metal-coated dielectric is undercut by an air region. The coating can also go only sidewalls and selected regions. Another embodiment uses multiple sizes and depths and shapes so that it can work for a variety of laser light wavelengths.

The Perney publications discussed above, and all other extrinsic materials discussed herein, are incorporated by reference in their entirety. Where a definition or use of a term in an incorporated reference is inconsistent or contrary to the definition of that term provided herein, the definition of that term provided herein applies and the definition of that term in the reference does not apply.

Kahl and Voges theoretical paper (“Analysis of Plasmon Resonance And Surface-Enhanced Raman Scattering On Periodic Silver Structures”, Physics Review B 61, 14078-14088, 2000) describe rectangular groove gratings that are periodic gratings including binary silver gratings and silver gratings on silica. Kahl and Voges stated that >80 nm is best for depths of the gratings for SERS, and that the silica gratings with isolated silver layers are superior to the binary silver gratings.

Nanowires and Gratings

Nanoparticles on nanowires have shown SERS enhancements. Cui et al. (“Polyimide nanostructures fabricated by nanoimprint lithography and its applications”, Microelectronic Engineering 83, 906-909, 2006) report producing polymer gratings using nano-imprint lithography. The gratings are covered with silver nanoparticles, which produced a SERS signal. The grating acted as a support for the nanoparticles. Wei et al. (“Polarization Dependence of Surface-Enhanced Raman Scattering in Gold Nanoparticle-Nanowire Systems”, Nano Letters 8, 2497-2502 (2008)) describes nanoparticle on nanowire systems and the SERS intensity as function of polarization angle.

Nanowire SERS substrates have been proposed utilizing anodic aluminum oxide (AAO) as templates for uniform nanowire synthesis. Electrodeposition, CVD or other techniques are used to fill the pores to yield nanowires of desired material type and dimensions (“Large-Scale, Reliable and Robust SERS-Active Nanowire Substrates Prepared Using Porous Alumina Templates”, J. Nanoscience and Nanotechnology 8, 931-935 (2008).)

Work at the Naval Research Lab (“Surface-enhanced Raman spectroscopy of dielectric/metal nanowire composites”, Applied Physics Letters 90, 093105 (2007).; “Dielectric and Geometric Properties of plasmonics in metal/dielectric nanowire composites used in SERS”, Proc. SPIE 6768, (2007) 676801; “Highly Efficient SERS Nanowire/Ag composites”, NRL Review 2007.; “Formation of ordered and disordered dielectric/metal nanowire arrays and their plasmonic behavior”, Proceedings of the SPIE, vol. 6768 (2007) 67680-E1), report results from various nanowire based structures for SERS applications. Zinc oxide (ZnO) and gallium oxide (Ga₂O₃) dielectric nanowires are synthesized and then coated with silver via electron beam deposition. Additionally, gold strips are patterned with electron beam lithography with relatively wide spacings of 186 nm spacing. No SERS enhancement occurs on the gold strips due to the wide gap. Hotspots and quality SERS imaging is found in randomly crossing nanowires with a polarization dependence. When a silver coated nanowire is deposited and randomly aligns parallel with one of the gold nanostrips, a strong SERS enhancement is observed. The chemicals under test for this work were Rhodamine 6G/methanol and DNT/methanol dilutions, which are often used in SERS experiments.

In U.S. Pat. No. 7,158,219, entitled “SERS-active structures including nanowires”, Li et al. describe a method of synthesizing dielectric nanowires by CVD, then coating a SERS active material on the nanowire core. In U.S. Pat. No. 7,391,511, entitled “Nanowires for surface-enhanced Raman scattering molecular sensors”, Bratkovski, et al. describes nanowires grown vertically or randomly with SERS active sites on one end of the nanowire as the localized hot spots.

Bratkovski, et al. also describes the use of protrusions such as sawtooth gratings, triangular or hemisphere protrusions, where the analyte molecules that fall in between the protrusions see large SERS enhancement factors in U.S. Pat. No. 7,391,511, entitled “Raman signal-enhancing structures and Raman spectroscopy systems including such structures”.

In U.S. Pat. No. 7,466,406, entitled “Analyte detection using nanowires produced by on-wire lithography”, Mirkin et al. describes the use of nanodisk arrays formed by patterning on top of nanowires with etching techniques as a method of hot spot formation.

Gratings as SERS substrates have a long history. Wirgin and Lopez-Rios (Opt Commun. 48, 416, 1984) produced a theoretical model describing the SERS activity of a silver grating. In Moskovits' review article of 1985 (Rev. Mod. Phys. 57, 796, 1985), he indicates that a randomly rough silver or gold surface such as those showing SERS activity could be thought of as a 2-D superposition of gratings with various pitch (i.e. as a 2-D Fourier superposition of gratings). Garcia-Vidal and Pendry reported a more up to date calculation of the SERS activity of gratings (Phys Rev Lett 77, 1163 1996). There are other papers reporting calculations on gratings (e.g. M. Kahl and E. Voges, “Analysis of plasmon resonance and surface-enhanced Raman scattering on periodic silver structures”, Phys. Rev. B 61, 14078, 2000).

Experimental demonstration of SERS from gratings is more scarce. The most commonly encountered (although not gratings per se as we describe in our disclosure, but a 2-D array of particles or posts that the examiner might include in the class) are 2-D arrays of nano-features most commonly fabricated using optical or electron lithography. (N. Félidj, J. Aubard, and G. Lévi, “Controlling the optical response of regular arrays of gold particles for surface-enhanced Raman scattering”, Phys Rev B 65, 075419, 2002; Gunnarsson, L.; Rindzevicius, T.; Prikulis, J.; Kasemo, K.; Käll, M.; Zou, S.; Schatz, G. C. J. Phys. Chem. B 2005, 109, 1079-1087; M. Sackmann, S. Bom, T. Balster and A. Materny, “Nanostructured gold surfaces as reproducible substrates for surface-enhanced Raman spectroscopy”, J. Raman Spectrosc. 2007; 38: 277-282).

Tuan Vo-Dinh includes a regular nanograting uniformly (in fact, conformally) coated with a metal in a drawn figure—an artist's conception—in his 1998 article (Trends in Analytical Chemistry, vol. 17, p 557, 1998) in which he enumerates plausible SERS-active surfaces.

Brolo et al. report SERS from lines scratched in Au surfaces that approximate the trenches that exist in a grating (Brolo et al. “Surface-enhanced Raman scattering from oxazine 720 adsorbed on scratched gold films”, J. Raman Spectrosc. 2005; 36: 629-634; J. Phys. Chem. B 2005, 109, 401-405) and Brolo et al. “Strong Polarized Enhanced Raman Scattering via Optical Tunneling through Random Parallel Nanostructures in Au Thin Films”, J. Phys. Chem. B 2005, 109, 401-405.)

Weak SERS emissions were reported in 1994 from spectrometer echelle-type gratings coated with silver and dosed with p-nitrobenzoic acid. The SERS signal was anisotropic according to the orientation of the polarization of the incident light with respect to the orientation of the grating suggesting that the grating was having an effect on the SERS emission. The geometrical features of that grating were not optimized for SERS and most of the SERS intensity reported actually resulted from the residual roughness in the deposited silver (Fujimaki et al. “Enhanced Raman Scattering from Silver Metal Gratings Coated with p-Nitrobenzoic Acid Films”, J. Raman Spectrosc, 25, 303-306, 1994).

Recently Kocabas et al. (“Plasmonic band gap structures for surface enhanced Raman scattering”, Optics Express 16, 12469, 2008) reported making bi-harmonic metal gratings that show SERS activity by using interference lithography to make a master with which they stamped substrates onto which they deposited metal and an adsorbate.

In U.S. Pat. No. 7,236,242, entitled “Nano-enhanced Raman spectroscopy-active nanostructures including elongated components and methods of making the same”, Kamins et al. describes an elongated component and fabrication methods thereof. The elongated component has two conducting strips (e.g. silver, gold, aluminum) with an insulation strip in between, where the insulating strip is preferably 0.5-5 nm wide. One method of manufacture is to deposit a dielectric material on the top and sidewalls of a sacrificial layer feature and use etching techniques to leave only the sidewall portion, then coat with a SERS active material use etching techniques to form conducting sidewalls of the SERS active material. The insulating strip is between the two SERS active material conducting strips. Other methods of fabrication are included based on etching methods. Nanoimprint lithography is also described in embodiments for patterning the conductive strips. Another embodiment uses lithography and etching techniques to create an elongated feature that is homogeneous, i.e. not two conducting strips with an insulating strip in between but metal features with an air gap.

Current methods for SERS substrates often rely on random or uncontrolled nanoparticle formation and/or nanowire positioning, which is not suitable for commercialization and efficient manufacturability. Several methods include controlled architectures but lack in the degree of SERS enhancement and precision of the SERS material proximity positioning. Photolithographic and nanoimprint lithographies combined with etching will likely not produce gap sizes between adjacent SERS material structures as required for very high levels of sensitivity for detection. Electron beam lithography is generally too expensive of a technique and not suitable for manufacturing.

Some SERS-based detectors are already known. For example, Concateno-Philips markets a Magnotech™ magnetic nanoparticle binder method and optical device, described as “on the go” drug test for specific chemicals (cocaine, heroin, cannabis, amphetamines, methamphetamines). A suspect individual spits into receptacle, which enters into handheld device, and delivers a color coded results in 90 seconds. The Magnotech technology is described in U.S. Pat. No. 7,048,890 entitled “Sensor and method for measuring the areal density of magnetic nanoparticles on a micro-array”.

Oasis Diagnostics markets a Sali•Chek™ On Site Drug Testing System for “immediate drug testing at the roadside, in schools, in the criminal justice system and other situations”. It is a saliva and oral fluid collection and testing system that can apparently test simultaneously for 6 drugs, including THC, cocaine, Methamphetamine, Amphetamine, Opiates and PCP.

The problem with these devices, however, include cost, sensitivity and reliability. What is needed is a more reproducible plasmonics substrate, which is manufacturable utilizing wafer scale processing, and which significantly improves upon currently available methods. A method is needed that can effectively control key parameters, optimize geometries for the plasmonics and SERS applications and, in the case of SERS, is not dependent on random or inconsistent effects often seen in other SERS substrate systems.

### SUMMARY OF THE INVENTION

The inventive subject matter provides apparatus, systems and methods in which a plasmonic device has a plurality of nanostructures extending from a substrate. Each of the plurality of nanostructures preferably includes a core, a coating of intermediate material covering at least a portion of the core, and a coating of a plasmonic material.

In preferred embodiments, a plasmonic device is manufacturing using the steps: of (a) applying a photoresist layer to the substrate; (b) performing lithography; (c) etching the substrate based on the exposure pattern to produce a plurality of nanostructure cores; (d) depositing an intermediate material onto the cores by a Plasma Enhanced Chemical Vapor Deposition (PECVD); and then depositing a SERS active material onto the intermediate material.

Cores can be arranged in any suitable pattern, including one-dimensional or two-dimensional patterns, and a given substrate could support both one-dimensional and two-dimensional patterns. Core gaps preferably separate the cores by a uniform distance.

The intermediate material covering the core is preferably dome-shaped. In some contemplated embodiments, the intermediate material may itself be etched during manufacturing, as for example to form V-shaped, and/or U-shaped, and/or parabolic-shaped structures. An adhesion material can advantageously be deposited between the intermediate material and the SERS active material.

The SERS active (i.e., plasmonic) material can comprise any suitable material, including for example the substrate material. The SERS active material deposited on the intermediate material can have any suitable thickness, but preferably has a substantially uniform thickness. The SERS active material on adjacent cores is advantageously separated by gaps having a size sufficient to be effective in a plasmonic process.

Functionality of the device can be enhanced in several ways, including altering the surface roughness of the SERS active material, as for example by electromechanically smoothing or roughening the surface of the SERS active material.

Plasmonic devices manufactured according to the concepts disclosed herein can produce a grating with small gaps in the range of 1-50 nm, which absorb >95% of the optimal incident laser beam close to surface normal incidence, with little or no diffraction for the incidence. Such devices can also advantageously absorb >90% of incident laser beam no less than +/−15 deg of angle of incidence (AOI), more preferably with the incident laser beam no less than +/−30 deg of AOI, and most preferably with the incident laser beam no less than +/−60 deg of AOI. Such devices can also advantageously absorb >50% of incident laser beam no less than +/−80 deg of AOI.

Independently, such devices can advantageously absorb >90% of incident beam within +/−10 nm of the optimal center spectral position at surface normal incidence, >90% with the incident beam within +/−25 nm of the optimal center spectral position at surface normal incidence, >70% of incident beam within +/−50 nm of the optimal center spectral position at surface normal incidence, and >50% of incident beam within +/−50 nm of the optimal center spectral position and over +/−15 deg. AOI for optimal polarization.

From a reflection perspective, contemplated gratings with small gaps in the range of 1-50 nm, can reflect <5% of the optimal incident laser beam close to surface normal incidence, where the said structure do not produce noticeable diffraction for the incidence, and more preferably <50% of incident beam within +/−50 nm of the optimal center spectral position and over +/−15 deg. AOI for optimal polarization. In terms of ratios, such gratings can advantageously exhibit a reflectivity within R0+/−5%, R0 being the optimal reflectivity of the incident laser beam close to surface normal incidence, when spectral range varied +/−20 nm, where the said structure do not produce noticeable diffraction for the incidence.

Contemplated gratings need not have such small gaps, however, and some gratings manufactured in accordance with the concepts disclosed can exhibit non noticeable diffraction for the incidence, when used in a detection device or system, while still generating significant difference in detection signal when the polarization orientation or properties of the incident excitation changes. Such multiples can be >10 times, more preferably >50 times, and most preferably >10 times.

Devices contemplated herein can be used in airborne analyte detectors, in handheld roadside controlled substance detectors, in genome sequencing device, and in refraction detectors.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

The inventive subject matter is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a flow chart diagram of the method for manufacturing a PECVD plasmonic structure;

FIG. 2 is a side-view illustration of the underlying layer in the plasmonic structure;

FIG. 3 is a side-view illustration of the PECVD silicon oxide coating on the layer shown in FIG. 2;

FIG. 4 is a side-view illustration of the PECVD silicon oxide coating with thin chrome sticking layer and gold layer on the layer shown in FIG. 2;

FIG. 5 is a cross-sectional scanning electron microscope (SEM) image of a PECVD plasmonic structure;

FIG. 6 is a cross-section illustration of the PECVD plasmonic substrate structure including gold nano-particles;

FIG. 7 is a flow chart diagram of the method of manufacturing a groove shaped plasmonic structure;

FIG. 8A is a top-view illustration of the structure shown in FIG. 2 with the PECVD silicon oxide coating, the with thin chrome sticking layer and the gold layer;

FIG. 8B is a top-view illustration of the structure shown in FIG. 2 PECVD silicon oxide coating, the thin chrome sticking layer and gold layer etched into V-groove;

FIG. 9A is a cross-sectional view illustration of the PECVD silicon oxide coated with a thin chrome sticking layer and gold layer;

FIG. 9B is a cross-sectional view illustration of the PECVD silicon oxide coated with a thin chrome sticking layer and gold layer etched into V-groove;

FIG. 10 is a perspective-view SEM image of the V-Groove substrate with 120 nm of gold deposited thereon;

FIG. 11 is a cross-sectional view of a transparent plasmonic substrate illustrating the back illumination technique;

FIG. 12 is a perspective-view of a plasmonic substrate with a buffer layer on top of the substrate material;

FIG. 13 is a perspective-view of a slide equipped with Microfluidics pathways;

FIG. 14 is a side-view of a robot equipped with a probe for use in detecting airborne analytes such as explosive residue disclosed in Example 1;

FIG. 15 is a front-view of a handheld roadside controlled substance detector as described in Example 2;

FIG. 16 is a front-view of a handheld roadside controlled substance detector with an optional probe as described in Example 2;

FIG. 17 is a schematic view of DNA strands inside the nano-channels with SERS active materials are on top of the channels;

FIG. 18 is a schematic view of DNA strands inside the nano-channels with multiple layers of plasmonic active materials on top of the channels; and

FIG. 19 is a schematic view of the patterned plasmonic structures enclosed, e.g., by cover glass, that forms chambers for spectroscopic detection.

FIG. 20 is a graph of reflection versus wavelength, which is useful for describing an embodiment of the inventive subject matter.

### DETAILED DESCRIPTION

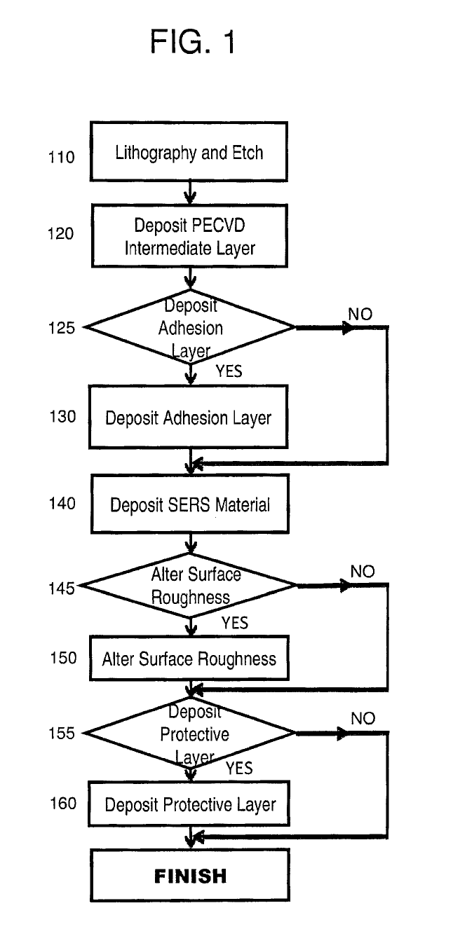

FIG. 1 is a flow chart diagram of an example method for manufacturing a PECVD structure. The first step in this method is to prepare the substrate from which or on which the plasmonic nanostructures are to be formed. It is contemplated that the substrate can be made entirely of a plasmonic material, or it can be made of a material that does not exhibit plasmonic activity but which is then coated with a plasmonic material.

The nanostructure features can be formed on a substrate so that there are nanometer scale gaps separating adjacent plasmonic active elements. It is difficult to make plasmonic structures because of the size of the gaps between the adjacent nanostructure elements. This spacing, which can be on the order of 1 nm to 50 nm, is difficult to consistently produce in a production environment. The plasmonic elements can be designed with specific architectures so that one or more analyte molecules can be positioned for analysis. The molecules do not necessarily need to be in the middle of the gap. Depending on the architecture, plasmonic “hotspots” can be between the gap or somewhere else on the nanostructure.

The substrate can be monolithic (e.g. a single-crystal silicon wafer) or it can be a multi-layer element having a nanostructure layer formed on top of a substrate. If the substrate is not formed from a plasmonic material, it can be any of a number of materials typically used in microelectronic devices including but not limited to glass, fused silica, quartz, silicon oxide, silicon, gallium arsenide, aluminum oxide, germanium or sapphire. The nanostructure layer formed on the substrate can be, without limitation, silicon oxide, silicon, aluminum oxide, metal oxide, metal—including a plasmonic material—or other dielectric or semiconductor material. This nanostructure layer can then be coated with a plasmonic material such as silver or gold. As an alternative, it is contemplated that either the nanostructure layer or the entire device can be formed of a plasmonic material. When the nanostructure layer is different from the substrate, there can be an etch-stop layer between the nanostructure layer and the substrate. For example, an etch-stop layer of HfO₂ can be deposited on a substrate and an SiO₂ nanostructure layer can be formed by selectively etching a material grown or deposited on the etch-stop layer. The microstructure cores can then be formed in the SiO₂ layer, as described below, using an etchant that preferentially etches SiO₂ relative to HfO₂.

The substrate can be processed using lithographic techniques to produce an array of nanostructures at step 110. The nanostructure array can be one-dimensional (1D) or two-dimensional (2D), as described below. The first step in the lithographic process is, at step 110, coating the substrate or nanostructure layer with a resist material. The resist material is then patterned according to a desired nanostructure array. After the photoresist is patterned, the portions not corresponding to the nanostructure array can be removed and the substrate is etched to form nanostructure cores.

The particular lithographic technique can be chosen from any known in the art such as photolithography, stepper photolithography, laser interference lithography, electron beam lithography, or deep ultra-violet (DUV) photolithography or nanoimprint lithography. During photolithography, a photoresist is exposed to a radiation source to form an exposure pattern. The exposure pattern defines the shapes of the nanostructures. As described above, in this example the portion of the photoresist that does not conform to the nanostructure array is removed.

For nanoimprint lithography, a mold containing nanostructures can be pressed into a resist to selectively remove portions of the resist material or to create contours in the resist material. The resulting structure can then be processed to remove thinned portions of the resist material prior to etching.

Once the resist material is removed, etching techniques such as wet etching or dry etching can be utilized to remove portions of the nanostructure layer or of the substrate between the nanostructure elements. If the resist material is a photoresist, it is contemplated that it can be a positive photoresist or a negative photoresist. The result of the etching process can be an array of one dimensional (1-D) or two dimensional (2-D) nanostructure cores. These etching techniques are desirably anisotropic to ensure that the nanostructure cores are not undercut. After etching is complete, the remaining photoresist on the substrate or nanostructure layer can then be removed before further manufacturing. The size parameters for the core structures can be anywhere in the range of 50 nm to 2000 nm. The polarization performance of the 1-D structures is anisotropic, while the 2-D structures and nanoparticle systems are not.

After the final pattern of photoresist is removed from the substrate or nanostructure layer, a plasma-enhanced chemical vapor deposition (PECVD) process is used to then grow a head around each grating line or post and create a gap that can be closed to a specified distance at step 120. A range of sizes for the PECVD before the plasmonic material is applied can vary from 10 nm to 10000 nm. The PECVD process applies the material at an angle approximately normal to the surface of the nanostructure cores. The PECVD process creates an intermediate material layer on top of the substrate that is used to close the distance between the nanostructure cores. The specified distance can differ between different plasmonic substrates depending upon the ultimate use of the substrate. The specified distance is determined by several factors including the type of analyte to be detected or analyzed. The size of the intermediate layer can also depend, for example, on the amount of plasmonic material to be applied, as described below.

Moving onto step 125, it is then determined whether an adhesion layer should be applied. The adhesion layer is typically a thin layer of a material that helps the plasmonic material to adhere to the nanostructure cores. In the example embodiment, an adhesion layer of chrome is used. If an adhesion layer is to be applied, step 130 applies the layer, for example, using PECVD and then step 140 applies the plasmonic material. If no adhesion layer is used, then the process proceeds directly from step 125 to step 140.

This plasmonic metal layer can be applied using e-beam evaporation or sputtering or other technique known in the art at a normal or near-normal angle of incidence to the front surface of the said substrate. The metal layer consists of a plasmonic material that coats the PECVD layer or the adhesion layer to allow the combined structure (substrate, intermediate layer and metal layer) to define nanostructures sufficient to be effective in a plasmonic process. By depositing the plasmonic material onto the nanostructure cores of a thickness of 50 nanometers to 2000 nanometers, for example, gaps can result between the nanostructures in the array can be in the range of 1 nm-50 nm, which is conducive to SERS analysis or MALDI.

MALDI is an acronym for Matrix Assisted Laser Desorption Ionization, which can include a matrix or be matrix-free. Conventional MALDI utilizes a laser beam to irradiate a sample that includes the target analyte(s) and a matrix material, where the analyte(s) may be biomolecules, polymers and other large organic molecules that are relatively fragile and require an ionization method that is not destructive. The matrix absorbs most of the energy and transfers energy to the analyte(s) causing them to be ionized. The ionized analyte(s) molecules are then measured by mass spectrometry. The matrix material is generally crystallized molecules with low molecular weight that are highly absorbing in the wavelength range of the incident light. MALDI substrates are highly efficient at absorbing energy from incident light, and can transfer energy to the analyte molecules for ionization while protecting them from destruction from the incident beam.

After the plasmonic material is deposited on the intermediate layer, step 145 determines if the surface roughness should be altered. For a SERS substrate, for example, surface roughness can be altered to enhance Raman excitation. At step 150, a surface altering process such as electrochemical roughening can be carried out, for example, by successively electrochemically oxidizing and reducing the metal electrode. This process re-deposits the metal irregularly upon reduction so as to promote surface roughness. If smoothing of the surface is desired, then an annealing procedure wherein the plasmonic structure is heated over a specific period of time. Both the temperature to which the structure is heated and the amount of time depend on the particular SERS material and can also depend on the geometry of the device. One skilled in the art would be able to determine an appropriate combination of electrochemical roughening and annealing to achieve a desired surface roughness without undue experimentation.

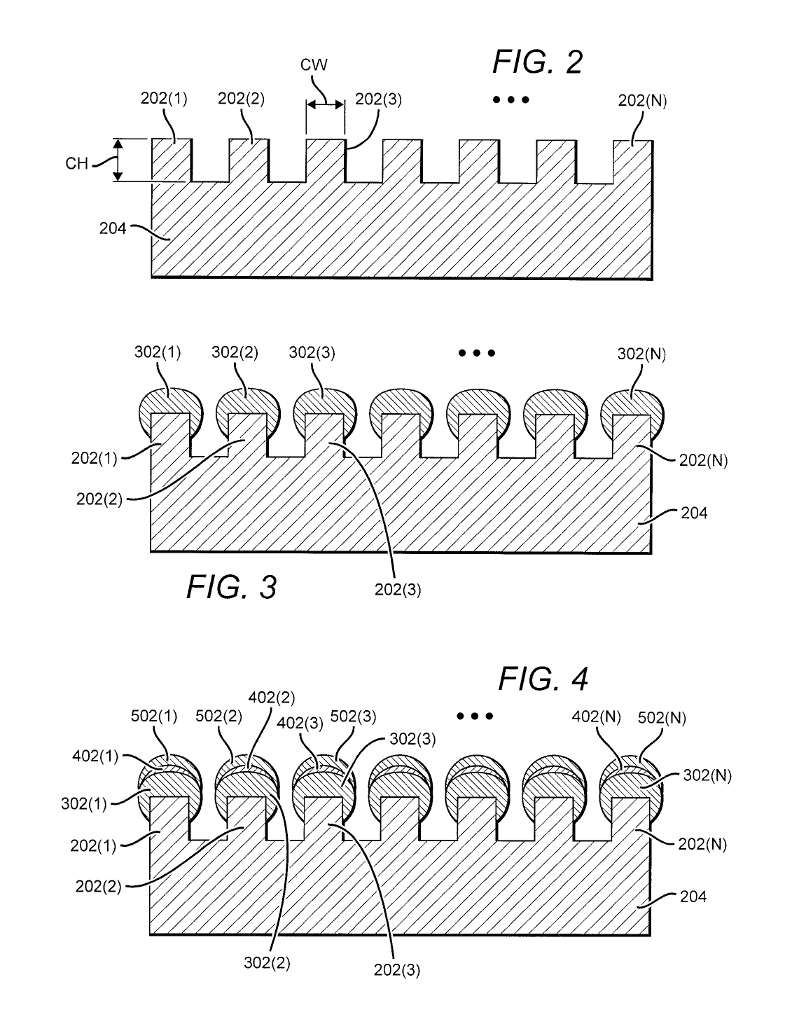

FIGS. 2-5 illustrate a first example of the plasmonic substrate formed in the manner described above. FIG. 2 is a side-view illustration of the underlying layer in the PECVD structure. This structure is illustrated as having monolithic cores, that is to say, cores formed from the substrate material. It is contemplated, however, that the structure can be formed in a deposited or grown nanostructure layer (not shown in FIG. 2) on top of the substrate.

The nanostructure cores have a height CH and width CW. The cores are also formed on substrate 204 at an appropriate uniform pitch, P, and separated by a gap, CG. In one embodiment, the cores can be constructed having a CG ranging from 50 nm-500 nm. It is noted, however, that P and CW can range between 10 nm and slightly less than 10 microns; CH can range from 10 nm to 10 microns or more and CG can range from 10 nm-500 nm.

It is understood by one skilled in the art, that the nanostructure cores can be formed without a uniform pitch P. In these embodiments, the pitch P can be varied based upon the application for which the substrate is to be used. Varying the pitch P can allow for a substrate to detect several different analytes or to develop a broader profile of a single analyte by using several different laser frequencies on one substrate. Furthermore, it is also understood by one skilled in the art, that when 2-D nanostructure cores are created, it is possible to create these cores with a different pitch P occurring along the X-axis when compared to the pitch P occurring along the Y-axis of a 2-D structure.

FIG. 3 shows a cut-away side-view illustration of a PECVD silicon oxide intermediate coating on the nanostructure cores in the PECVD structure. A PECVD silicon oxide coating 302(1)-302(N) is deposited on each of the nanostructure cores of the substrate. In this example the intermediate material is silicon oxide 302(1)-302(N). The silicon oxide coating is deposited on each one of the nanostructure cores 202(1)-202(N). The silicon oxide coating is controlled to be deposited until the specified distance d is achieved between each of the coatings. As mentioned above this distance, plus the depth of the plasmonic material, correlates to the distance desired to detect a particular analyte or analytes.

FIG. 4 shows a cut-away side-view illustration of the PECVD silicon oxide coating with thin chrome sticking layer 402(1)-402(N) and gold layer 502(1)-502(N) in the PECVD structure. In the present example the thin chrome layer 402(1)-402(N) can be applied to the top of the silicon oxide coating 302(1)-302(N). The thin chrome layer 402(1)-402(N) can serve as a sticking layer to better hold the plasmonic material, which can be deposited on top. In the present example, the plasmonic material that is placed on top of the thin chrome sticking layer 402(1)-402(N) is gold. Any, plasmonic material can be chosen to be placed on top of the intermediate material including, but not limited to gold, silver, copper, platinum, palladium, titanium, aluminum, lithium, sodium, potassium, indium or rhodium or combinations thereof to produce a plasmonic structure.

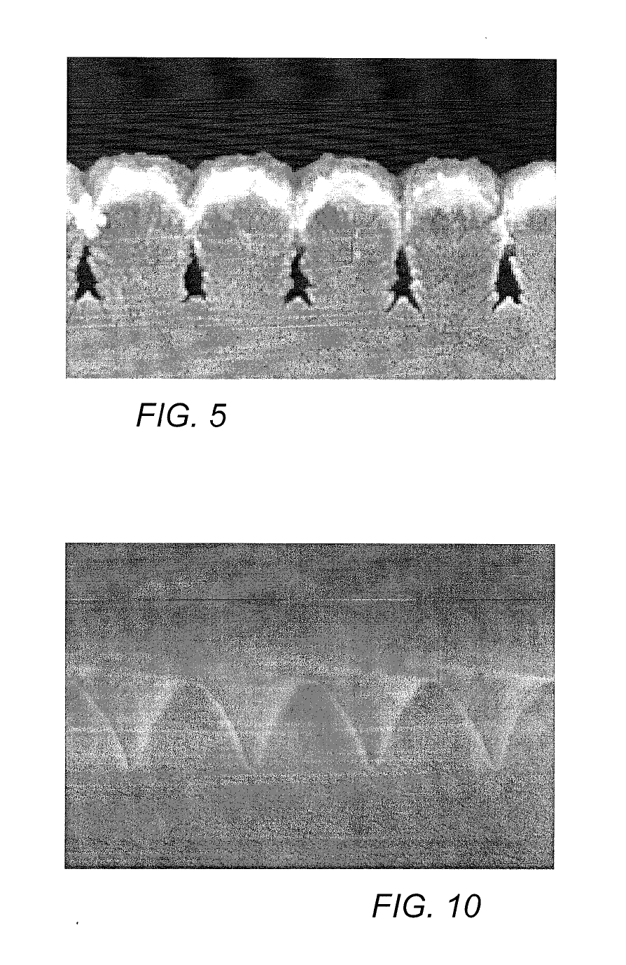

FIG. 5 shows a cross-sectional photomicrograph view of an example PECVD silicon oxide coated with a thin chrome sticking layer and gold layer. The example structure shown in the photomicrograph the nanostructure cores have a grating pitch of approximately 330 nm. The example structure was formed in a substrate using laser interference lithography, also known as holography. Each nanostructure core has a depth of approximately 150 nm and width of approximately 150 nm. 263 nm of PECVD silicon oxide is coated on the nanostructures, which is then coated with a thin chrome sticking layer, for example, in a range of thicknesses 2 nm to 10 nm and approximately 120 nm of gold.

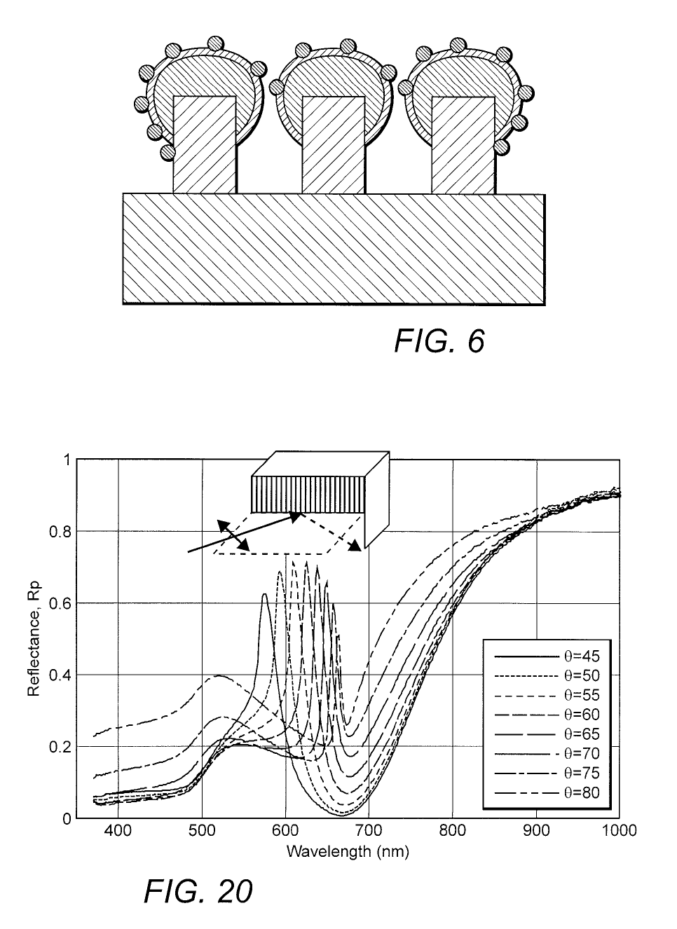

FIG. 6 also shows an alternative embodiment of the plasmonic structure in which nanoparticles are added on top of the plasmonic structure described above. Such as gold or silver colloid particles are formed directly or on top of thin layer of plasmonic material formed by atomic layer deposition (ALD) or similar coating technique. When used in a SERS application, the gold nanoparticles can increase the SERS enhancement between 2 to 10 times.

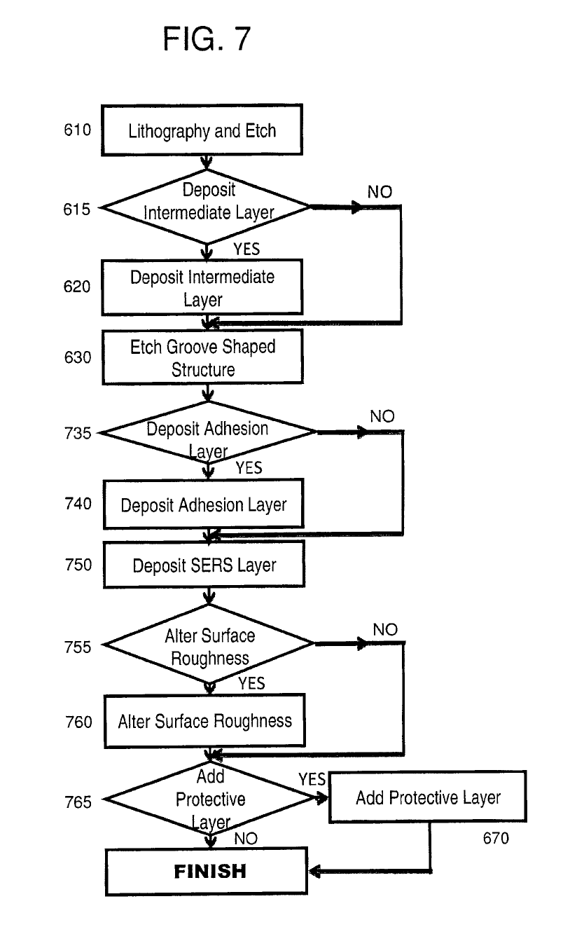

Described herein below is a second example embodiment of the inventive subject matter. FIG. 7 shows a flow chart diagram of the method of manufacturing a groove-shaped plasmonic substrate. Although all examples and embodiments that are described above, can not be described below, it is understood by one skilled in the art, that all of these examples and embodiments can be used to create the groove-shaped plasmonic substrate.

The examples described herein are not limited to the PECVD process to create the intermediate layer. Other methods such as atomic layer deposition, sputtering, thermal evaporation, electron beam deposition can be used in addition to or in place of the PECVD process. Atomic layer deposition can be used, for example, where the intermediate material deposited on the nanostructure cores has dimensions such that only a thin layer of plasmonic material is needed.

Starting at step 710, the groove-shaped plasmonic substrate is created by a process similar to the PECVD structure described above. The substrate material is converted into a plurality of one-dimensional or two-dimensional nanostructures (i.e. nanostructure cores) extending from the substrate through the use of either lithography or etching. The excess substrate material is removed until the desired shape of the nanostructure cores is achieved. The nanostructure materials can be monolithic with the substrate or can be formed from a material deposited or grown on the substrate as described above.

It is understood by one skilled in the art, that one dimensional (1-D) or two dimensional (2-D) nanostructure cores can be constructed. The nanostructure cores can also be formed with or without an appropriate uniform pitch P. In embodiments within a non-uniform pitch, the pitch can be varied based upon the application for which the substrate is needed. It is also understood by one skilled in the art, that when 2-D nanostructure cores are created, it is possible to create these cores with a different pitch or pitches P along the X-axis when compared to the pitch or pitches along the Y-axis of the 2-D structure.

At step 715, the cores are evaluated to determine whether an intermediate layer is to be deposited. If an intermediate layer is to be deposited, this is done at step 720, an intermediate material can be applied to the nanostructure cores through a process such as PECVD or the like. Although the above example grows the intermediate material through the use of the PECVD process, it is understood to one skilled in the art that other processes as described above can be used to coat the nanostructure cores with the intermediate material.

At step 730, the nanostructure cores and the intermediate material are etched to form a groove-shaped structure. The groove-shaped structure can be made with laser interference lithography, photolithography, stepper photolithography, electron beam lithography, deep ultra-violet (DUV) photolithography, nanoimprint lithography, soft lithography, or any other such method known in the art. Instead of coating the PECVD structure with metal and completing the device, it is etched into the groove-shaped structure before the plasmonic substrate is completed.

It is understood to one skilled in the art that, although V-shaped groove structures are described, once the intermediate layer has been formed on the nanostructure cores, many different groove shapes can be formed including but not limited to U-shaped grooves, parabolic grooves, or any other such groove shapes known in the art. Furthermore, multiple groove shapes, depths or widths can be utilized within the same SERS substrate. By altering the shape of the groove, the depth of the groove and/or the width of the groove, the plasmonic substrate can be in different types of plasmonic devices, to detect different analytes, or to detect a single analyte or multiple analytes in different conditions.

Next, the example process determines if the groove-shaped structures on top of the substrate can be prepared with an adhesion layer at 735. If an adhesion layer is to be used it is applied in step 740. As described above, this adhesion layer can be used to more easily bind the plasmonic material to the intermediate layer. Once the adhesion layer has been applied, or in the event that no adhesion layer is applied, the process advances to step 750, wherein the plasmonic material is deposited on top of the groove-shaped structures. This deposition of the plasmonic material can include any materials and methods described above.

Finally, upon the deposition of the plasmonic material for example, gold, the process can or can not alter the surface roughness of the SERS active material as described above and shown in step 760. Once the surface area roughness has been altered, or in the event that the surface area roughness is not altered, the example process is complete.

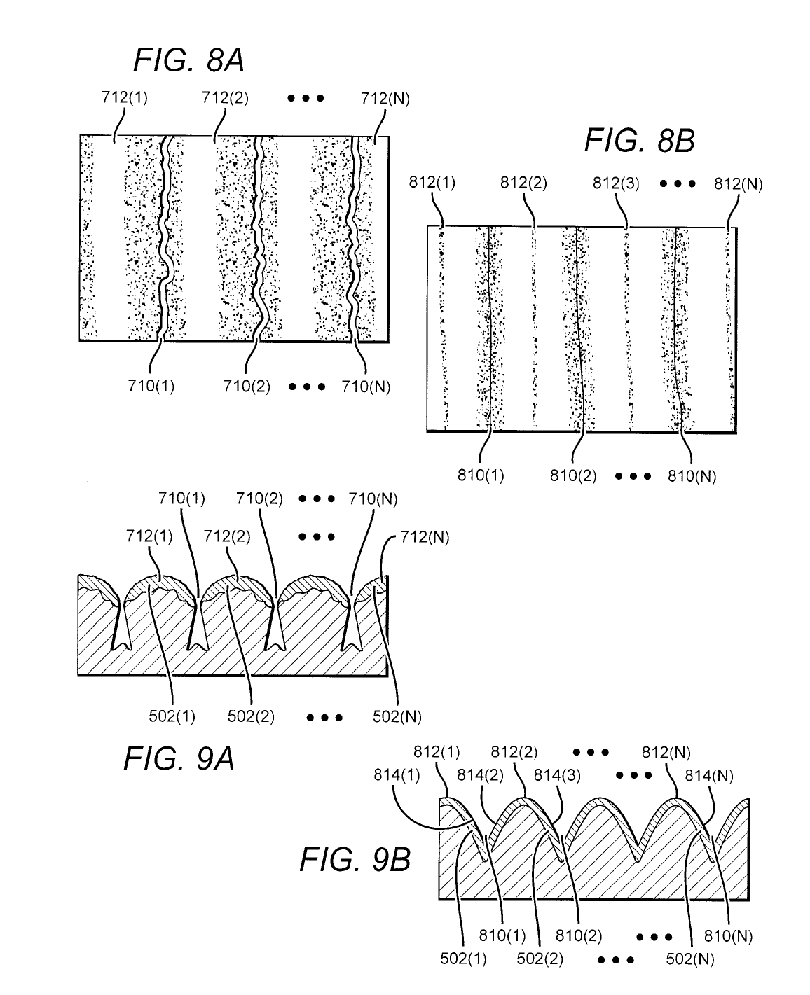

FIG. 8A shows a top-view illustration of the of a PECVD silicon oxide coating with a thin chrome sticking layer and a gold layer. This drawing can be contrasted with FIG. 8B which shows a top-view illustration of a thin chrome sticking layer and a gold layer coated onto a V-Groove. The V-Groove is formed starting with a PECVD silicon oxide coating. As shown in FIG. 8A, gaps 710(1)-710(N) are shown between the various SERS active areas. The example trenches and gaps 810(1)-810(N), as shown in FIG. 8B, appear smoother than the gaps shown in FIG. 8A, because of the V-Groove etching process. Similarly, the example peaks 812(1)-812(N) of the V-Grooves are also smoother as shown in FIG. 8B when compared to the typical plasmonic structure 712(1)-712(N) shown in FIG. 8A.

FIG. 9A shows a cross-sectional view of the PECVD silicon oxide coating with a thin chrome sticking layer and a gold layer. This drawing can be contrasted with FIG. 9B which shows a cross-sectional illustration of a PECVD silicon oxide coating with a thin chrome sticking layer and a gold layer etched into a V-groove structure. This drawing illustrates the differences between the two structures highlighting the smoothness of the sloped walls 814(1)-814(N).

FIG. 10 shows a top-view photomicrograph of the V-Groove structure including an etching performed through reactive-ion etching (RIE) (here CHF3/O2/Ar gases with the PlasmaTherm 720 etcher to remove ˜320 nm of silicon oxide) to form grooves in a V-shapes. The photomicrograph shows the PECVD structure after the RIE etch and after it is coated with a sticking layer and then gold.

For all embodiments and examples of the inventive subject matter, during analysis, an analyte can be applied to the plasmonic structure. The analyte as well as the photonic structure can be irradiated by a laser beam. The resultant scattered laser beam or radiation emissions caused by the laser beam and the photonic structure can then be detected by one or more detectors. In a SERS or MALDI device, radiation emitted by the analyte in response to the intense localized electric fields generated in the plasmonic substrates can be detected. For SPR or LSPR, such emissions caused by plasmons or a shift in the angle of reflection caused by a localized change in the index of refraction of the device can be detected. For any of these devices, the system can also include filters to separate the Raman scattered light from Rayleigh scattered light.

Similarly, the substrate can be manufactured as a transparent structure such as glass or other material that is transparent to radiation at the wavelength of interest. For example silicon is transparent to some infrared wavelengths. In this embodiment, the laser beam can be emitted from below the plasmonic structure, which will then pass through the transparent substrate and the SERS gaps. The laser beam will then scatter off of the plasmonic material and the analyte. The detector, which is also mounted below the transparent substrate, will then detect the scattered laser beam.

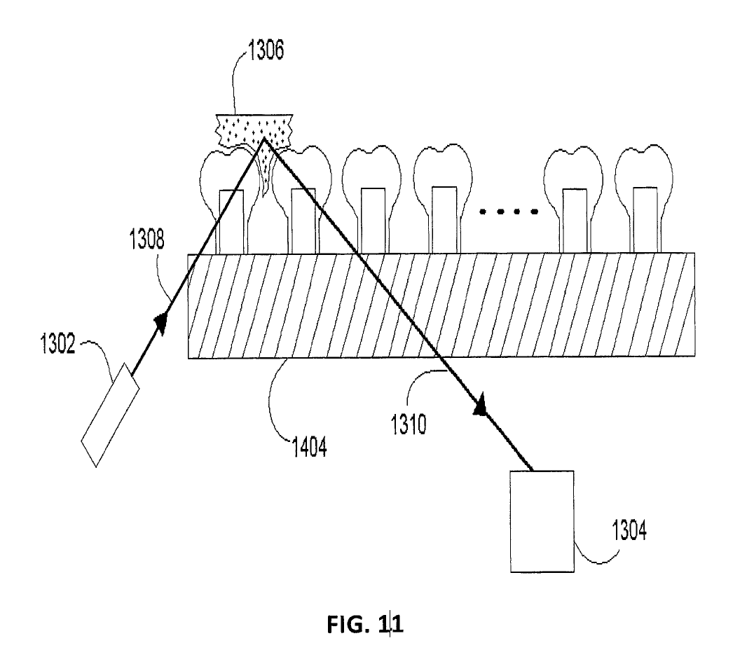

An example of the transparent structure is shown in FIG. 11. FIG. 11 illustrates back illumination detection in which the laser beam source 1302 is located behind the transparent substrate 1404. The laser beam 1308 passes through the transparent substrate 1404 and makes contact with the plasmonic material and/or the analyte 1306, at which point, the Raman scattering or plasmon generation occurs. A detection beam 1310 passes back through the transparent SERS substrate 1404. This detection beam can be Raman light emitted by the analyte or the incident laser beam 1308 shifted in its angle of reflection due to the localized index of refraction of the analyte. In the back illumination technique, the detector 1304 can also be located on the behind the transparent plasmonic substrate 1404.

For the presented examples and embodiments, the scattered laser beam can be analyzed to identify specific molecules in the analyte. The example plasmonic substrates, described above, can be sold commercially by packaging under dry nitrogen in diced sizes. Users can then dose samples onto the substrate using a micropipette and perform SERS, MALDI, refractive index analysis or other plasmonic analysis technique. One plasmonic substrate can be usable to perform multiple plasmonic techniques or to perform multiple analyses using a single technique. For example, by using non-overlapping areas on a substrate dosed with separated analytes, a single substrate could be used to detect an analyte from separate sources. These separated spots may, for example, be separated by a distance of 0.5 mm. By performing Raman spectroscopy on the SERS substrate, the user will be able to effectively target specific biomarkers of various biofluids.

For the presented examples and embodiments, the plasmonic substrate can be functionalized to enhance the ability to detect a particular analyte or group of analytes. For example, in a SERS process, the surface of the plasmonic material can be coated with a chemical or material that causes a particular analyte or group of analytes to deposit preferentially at or near the areas of highest SERS enhancement. The chemical or material can be added by immersion, dip coating, thin film deposition techniques, exposure to chemical vapors, or other technique known in the art. In addition it is contemplated that different sub-areas of the SERS substrate can be functionalized to enhance the ability to detect respectively different analytes or groups of analytes by applying respectively different surface treatments to the different sub-areas.

As described above, it is contemplated that the plasmonic substrate can be utilized in matrix assisted laser desorption ionization (MALDI) processes, which can be with or without the matrix. When used without the matrix, the plasmonic substrate performs the function of the matrix. Conventional MALDI utilizes a laser beam to irradiate a sample that includes the target analyte(s) and a matrix material, where the analyte(s) can be biomolecules, polymers and other large, fragile organic molecules. The matrix absorbs most of the energy and transfers energy to the analyte(s) causing them to be ionized. Radiation emitted by the ionized analyte(s) molecules can then measured by mass spectrometry

In the case of these substrates, the substrate itself is highly efficient at absorbing energy from incident light and can transfer energy to the analyte molecules for ionization while protecting them from destruction by the incident beam. A matrix material can not be necessary; however, the substrates can be used in conjunction with a matrix in another embodiment.

The substrates remain reliable and reproducible substrates for surface enhanced Raman spectroscopy with consistent and large enhancement factors. They are stable to sample swab transfers, can be used in a wet or dry, or moisture rich environment. The substrates may be operated under static or flow conditions. Nanoparticles bound to the surface are known to increase the signal due to specific formation of resonant hot spots or junctions between metal nanoparticle and substrate.

The substrate surface itself or attached structures can be modified so as to alter or tune their selectivity towards a particular analyte or family of analytes molecules. Substrates therefore may have multiple layers, each on their own or in combination to consist of a particular purpose for improving or reducing the binding of one or more species. For example, including a first layer on the metal for allowing physicochemical adsorption of analyte. A second layer for allowing selective transport molecules based on chemical properties (hydrophobic/hydrophilic, charge, host-guest, or molecular imprinting). A third layer could be a low resistance path for the bulk fluid access or fluidic pressure systems (passive or active). A fourth layer would seal the system from evaporation and stabilize the sensing elements for storage prior to use.

### EXAMPLE #1

One use and embodiment of the inventive subject matter discussed above relates to the use of plasmonic substrates in a SERS process for airborne analyte detection. This example relates to the development of nanograting array-based SERS substrate into a device that can detect an analyte present in the air or when the substrate comes into direct contact with an analyte. Analytes in air, can have very low concentrations e.g. few molecules or hundreds of molecules or ppm, ppb, or ppt. These molecules can be blown across or attracted to the substrate and adsorbed or attached to allow for measurement.

The embodiment can use substrates that are reliable and reproducible substrates such as the plasmonic substrates described above. The substrates can collect the analyte molecules from the air and can also include a concentration mechanism for enhanced low concentration detection. For example, the substrate can be coated with a material to which the desired analyte has a strong affinity. The substrate can be manufactured utilizing wafer scale processing and significantly improves upon currently available methods for making similar substrates. The manufacturing process provides control over key parameters, optimized geometries for SERS and the analyte molecules to be detected, long shelf-life products, flexibility, known SERS enhancement factors, and is not dependent on random or inconsistent effects often seen in other SERS substrate systems. Additionally, it the substrates can be cost effectively produced and high quantity capable. The manufactured substrates provide reliable and reproducible substrates to allow for the continued growth of SERS technology and application.

The airborne sensitive version described herein has several applications including, but not limited to: explosive detection, IED detection, homeland security, defense and military applications, police applications, narcotics detection, customs entry & immigration, standoff detection, e.g. of unknown packages and materials, e.g. on a robotic platform, detection of spoiling of foods, and the detection of buried human remains.

Handheld devices for the detection of airborne analytes are known in the art, however, these handheld devices do not utilize plasmonic substrates in a SERS process as described herein. In some embodiments of example 1, the SERS substrate can be kept moist by making appropriate contact between the substrate and a source of water, making use of the capillarity of its nano-channels to both draw water into the SERS active portions of the substrate and to retain the water in situ by surface forces. Allowing water to periodically wet the surface with a very thin layer could serve both as a means for providing a solvent into which airborne molecules and other analytes can dissolve, rendering them susceptible to analysis by SERS, and as a means for cleansing the surface for subsequent analysis. It should be understood by one skilled in the art, that other solvents beside water can be used to render the substrate more specifically sensitive to various classes of analytes. Such solvents can include aqueous and non-aqueous media, and solutions containing materials that can act as chemical recognition agents for the target analyte. Alternatively the liquid can be a cleaning agent such as hydrogen peroxide solution, and the substrate might be alternately connected to two sources of liquid, one for the cleaning treatment, another that serves as a solvent for the target analyte. In other embodiments of the inventive subject matter, it is understood by one of skill in the art that SERS substrate can still operate even if it is not kept moist, however, the measurement for determination of an analyte must take into account the knowledge that the substrate is not kept moist.

The liquid source (e.g. water, solvent, etc.) can be applied continuously or in a pulsed manner, e.g. prior to a measurement or as needed. In the non-continuous method, measurement can occur immediately, or after the liquid layer is fully or partially dried, so as to return the refractive index of the surrounding medium closer to that of air. In the continuous liquid flow method, e.g. where there is a constant thin liquid film, the measurement can be single measurement or multiple measurements. The multiple measurements can be taken at a programmed rate. The multiple measurements can also be aided by re-circulating the liquid. During the sensing and operation, some embodiments of example#1 the liquid can be re-circulated which allows for a build-up of analyte. This buildup allows for the airborne analyte detector to have a greater sensitivity by concentrating the analyte through collection over a period of time.

A simple method is used to wet the surface. In some cases, only the lateral nanochannels inherently formed in the SERS structure are made wet. One method for providing the liquid can be either a pulsed or continuous drop of very small volumes of liquid and let surface wetting spread onto substrate. In this method, there can be a liquid pulse, a drying interval, a liquid pulse, a drying interval, etc. According to this method, the wet stage is used to collect ambient molecules to the SERS substrate and the drying interval is used to aid adherence to substrate before the substrate is irradiated to detect the analyte. As known to one of skill in the art, the measurement can be done in air when the substrate is dry or wet.

Another method for adding the liquid can be by a simple automated syringe. This liquid can be stored in a reservoir that is connected to the syringe or other type of delivery method. The reservoir can be external to the substrate or on the substrate. In some embodiments, it can be liquid in an automated syringe or similar device. The syringe can provide a continuous or pulsed amount of liquid when the unit is in collection mode, and stop when it is not, thus extending reservoir time. The liquid can be recycled back to the reservoir, whether external or on substrate, which can aid in concentration of analyte, unless the amount of liquid is so small that it evaporates and there is nothing left to recycle after it has spread on the substrate.

If there is enough liquid flowing, it can be useful to recycle the liquid to the reservoir. This recycling process can be helpful to concentrate the analyte in the liquid. When the liquid is recycled, it is routed through the reservoir and back into the SERS substrate (e.g. if the liquid is pulsed/added on the left side, travels to the right and exits into a collector that routes it back to the liquid source).

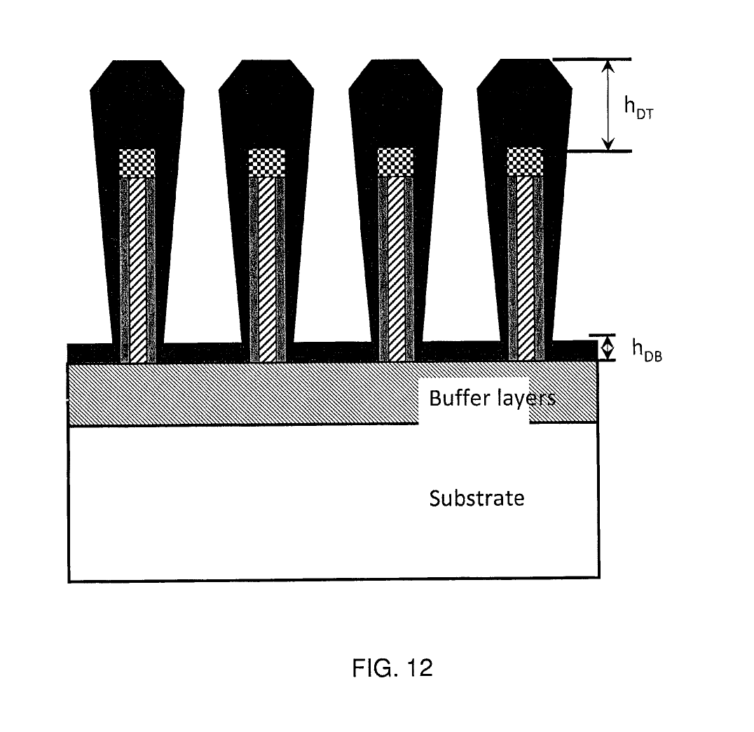

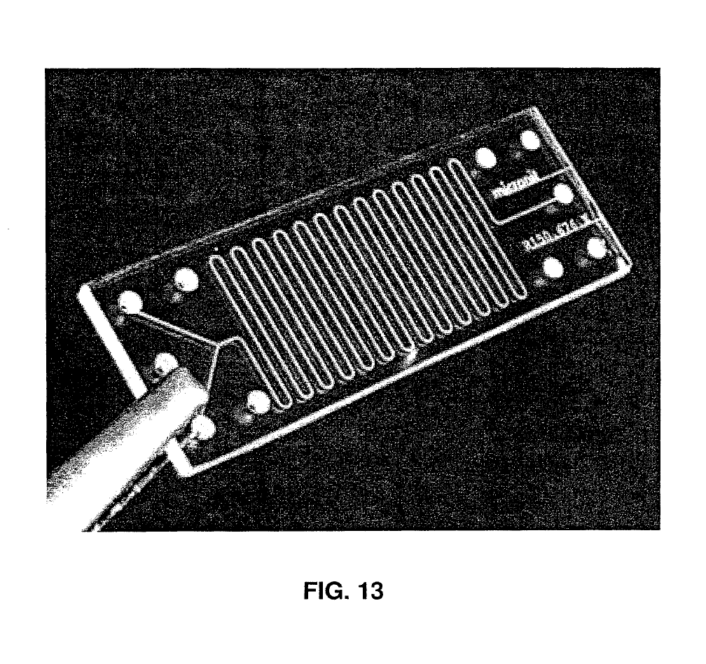

Embodiments of example 1 can also include Microfluidics. The Microfluidics can be included in the SERS system so that the liquid can be routed over the SERS active area (hotspots) multiple times and/or across multiple areas. Potentially a continuous loop or multiple laps around the device can be made with re-exposure to air for more analyte exposure between laps. An example of the Microfluidics pathways is shown in FIG. 13. FIG. 13 shows an inlet and an outlet and routing in between. The routing design, number of inlets and outlets, can be readily customized as known to one skilled in the art. The SERS devices can be fixed to a Microfluidics device similar to FIG. 12 in designed detection areas. The SERS substrate is much smaller than the 3″×1″ slide described below.

To ensure airflow across the SERS substrate, the device in Embodiment 1 can include a small fan or other blower device that collects air either from a selected direction or from many directions, and channels the collected air across the substrate.

In addition, to provide an enhanced ability to detect airborne molecules or biologics, the device in Embodiment 1 can also include a mechanism to scan the laser beam over the entire surface of the SERS substrate. This mechanism can physically move a diode laser across the substrate or it can use a stationary laser and scan the beam using one or more scanning mirrors. Other methods for scanning a laser beam can also be used.

As described above, each analyte emits a predetermined Raman spectrum in response to excitation by laser light. The wavelength of the laser can be a factor in designing a device to detect a particular analyte or analytes. The level of enhancement of Raman emissions can also depend on the size of the gaps between adjacent nanostructures on the SERS substrate and on the polarization of the laser light. An embodiment of an airborne analyte detector as described in example 1 can be configured to provide multiple gap sizes on a single SERS substrate or multiple substrates, each with a different gap size. In addition, the substrates can be used with or without nanoparticles bound to the surface. As described above, SERS substrates with bound nanoparticles can provide further enhancement of Raman spectroscopy relative to substrates without nanoparticles.

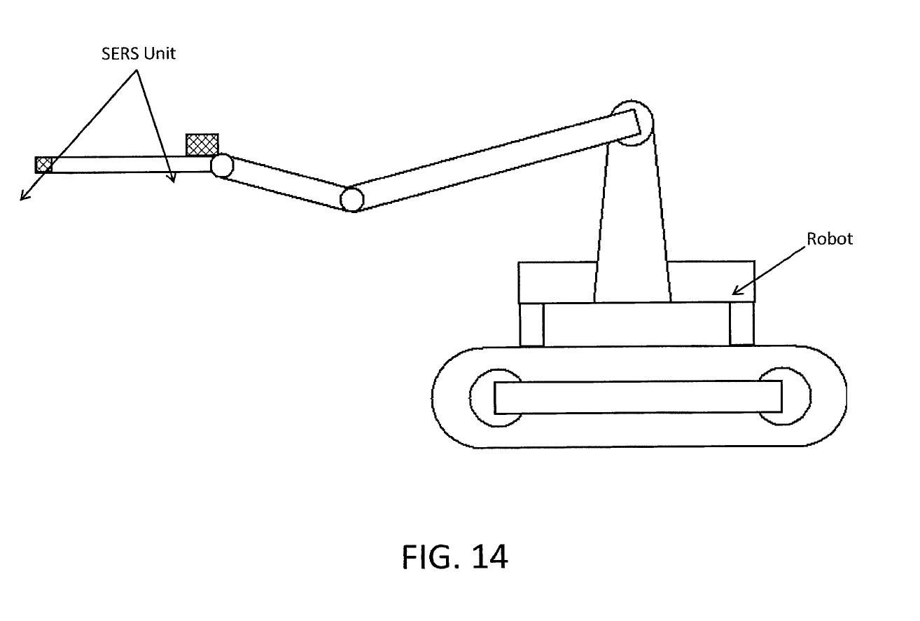

The device in example 1 measures Raman emissions from the device in response to the application of laser light. The measurements can be taken and analyzed on the device and/or sent to a remote station for analysis, e.g. wirelessly to another device, e.g. a handheld device or laptop or to a central monitoring station. Such central monitoring stations can have additional databases and support personal that can relay results and advise on how to proceed with an indicated hazard. As shown in FIG. 14, the detector can be equipped onto a probe attached to a robot for analyzing the explosive materials, which allows humans to maintain a safe distance from a suspected explosive. This embodiment of the airborne analyte detector is can be used by military and police bomb squads.

example 1 provides a method for detecting explosive, controlled substances and airborne biologics, with the possibility of simultaneous detection of several different agents at a high sensitivity level and with fewer false positives than other methods. This device also provides a higher level of reproducibility than other methods. Furthermore, embodiments of the inventive subject matter can be tested for contamination. To test for contamination, one skilled in the art can perform a test measurement prior to exposure, e.g. a control run on the same tool used for the target analyte(s) detection or different tool (i.e. desktop tool in the lab). If the measurement before exposure deviates significantly from a known baseline, it can indicate contamination.

The airborne analyte detector discussed in example 1, provides numerous advantages over the known prior art. These advantages include, but are not limited to: reproducibility, wafer scale production, reliability, consistency, designs that can be tailored to different analyte detections, high levels of sensitivity, control over key parameters, optimized geometries for SERS and the analyte molecules to be detected, long shelf-life products, passivation layer as anchor for chemical functionalization as needed, flexibility, known SERS enhancement factors, no dependence on random or inconsistent effects often seen in other SERS substrate systems, cost effective production, high quantity capabilities. In addition transparent substrates can be used allowing SERS excitation from both front or back surface. Furthermore, the substrates are compatible with most Raman spectrometers, including portable Raman equipment.

### EXAMPLE #2

In a second example, the SERS substrates described above can be used in a controlled-substance detection system. The device can be used to test for many controlled substances. This example integrates the nanograting array-based SERS substrate into a device that can detect controlled substances in low concentrations. The SERS substrate can be used in conjunction with a handheld unit for roadside drug detection applications, such as for the enforcement of driving under the influence laws, or in a desktop unit such as in a laboratory, hospital or forensic laboratory setting.

The substrates provide reliable and reproducible substrates for surface enhanced Raman spectroscopy with consistent and large enhancement factors. As described above, the SERS substrates are stable to sample swab transfers, can be used dry or in a moisture rich environment. The substrates can be operated under static or flow conditions. The substrates can be used with or without nanoparticles bound to the surface. As described above, SERS substrates with bound nanoparticles can provide further enhancement of Raman spectroscopy relative to substrates without nanoparticles.

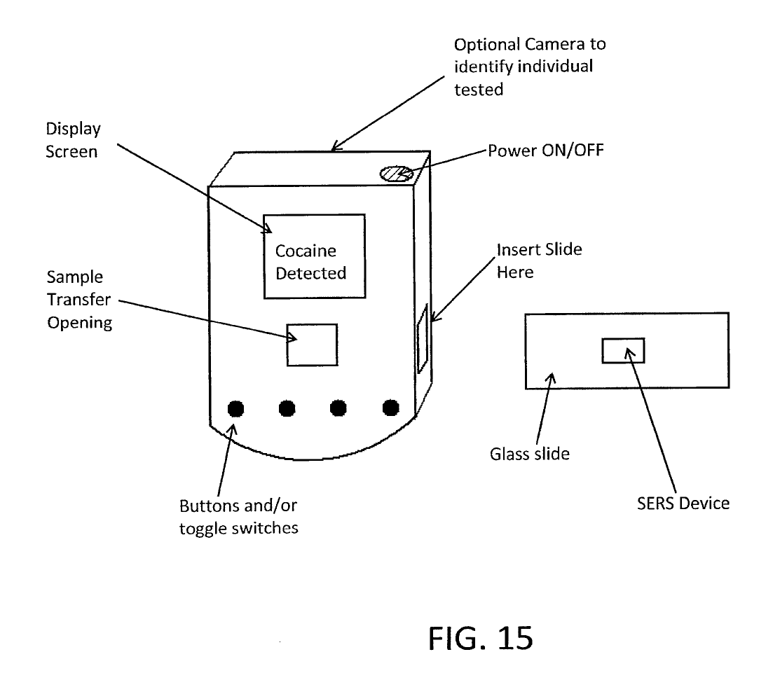

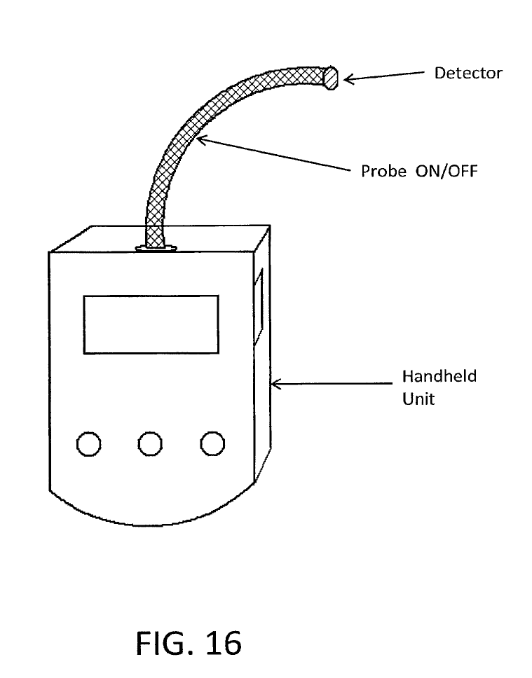

The substrate surface itself or attached structures can be modified so as to alter or tune the substrate's selectivity towards a particular analyte or family of analytes molecules. In the second example, the substrate can be altered to detect a variety of controlled substances at once. Substrates therefore can have multiple areas in combination each addressing a particular analyte by either improving or reducing the binding of one or more species of controlled substances. For example, including a first type of area on the substrate can allow for physicochemical adsorption of an analyte. A second area can provide selective transport molecules based on chemical properties (hydrophobic/hydrophilic, charge, host-guest, molecular imprinting or antibodies to bind to specific biologics). A third area can provide a low resistance path for the bulk fluid access or fluidic pressure systems (passive or active). The entire device can be sealed to stabilize the sensing elements for storage prior to use. It is understood to one skilled in the art that the inventive subject matter is not limited to the use of these three types of areas and can include other types of areas for the selective detection of analytes. As shown in FIG. 15, a handheld controlled substance detector can be used to test for controlled substances away from a laboratory. The handheld device of FIG. 15 utilizes a SERS substrate placed on a slide. A sample to be tested can be placed onto the SERS substrate and then the slide is inserted into the handheld device for analysis. Optionally, as shown in FIG. 16, the handheld device can be equipped with a probe detector that allows a test subject to insert saliva or other bodily fluid via the remote probe.

The roadside drug detection application would be saliva based, as it is non-invasive and easily administered. A test at a clinic or forensic lab could also include other bodily fluids, e.g. urine or blood. In the case of cocaine, one can test for cocaine itself in saliva or for its metabolites. Cocaine's primary metabolite is in benzoylecgonine, which can be present in the body for 2-4 days (up to 30 days for chronic users). The metabolite is more present in urine than saliva. Saliva tests can require better sensitivity than urine due to the concentration of controlled substance in the saliva being less than that of urine. For example, a test for cocaine in urine can be acceptable at 300 ng/ml (˜1 micromolar concentration) but require 20-50 ng/ml in saliva—this points to the need for highly sensitive devices.

In an exemplary embodiment, 1 mM cocaine in water was spiked into a tube containing ˜100 microliters of saliva to a concentration of ˜0.1 mM. A swab was immersed and then rubbed across the SERS sensing substrate (LT), covered with a glass coverslip and analyzed with a 10× objective on the Aramis Raman system. 633 nm excitation laser, 2.8 mW at sample, 1 sec×30 accumulations.

In another exemplary embodiment, 5.5 microgram/mL thionin acetate in water (8.7 micromolar) was spiked into a tube containing ˜100 microliters of saliva to a concentration of ˜1.7 micromolar. A swab was immersed and then rubbed across the SERS sensing substrate and covered with a glass coverslip. The surface was analyzed with a 10× objective on the Aramis Raman system. 633 nm excitation laser, 5.6 mW at sample, 1 sec×1 accumulations. Rotating the sample 90 degrees reduced the signal.

Microfluidics, as discussed above, can also be incorporated into the SERS device/slide. Microfluidics would be used to route the material, e.g. saliva. Dilution can be used, mixtures, etc. other standard “Lab-on-chip” methods can be incorporated as are known in the art.

In the handheld device, the slide would not need to move. An array of optical fibers, for example, can carry multiple beams in some orientation different areas on the slide or to multiple slides. The detector can be aligned to capture the reflected beam(s) or to detect Raman scattered light emitted from the test sample. For the desktop units, the same optics that are closest to the measured sample are generally used. A cover slip can be utilized over the substrate, however, it is not required.

Handheld controlled substance detectors are known in the prior art. These detectors, however, do not use SERS substrates such as those described above and therefore can not produce the desired results.

The SERS substrate utilized for the handheld controlled substance machines can be made and used in the same fashion as described above. In this example, the analyte molecules can be transferred to the substrate, e.g. dropwise, by direct contact from a cotton swab that contains saliva from an individual, from a tube that is placed in an individual's mouth and uses capillary effects to draw in saliva, or other transfer of an analyte that is in a liquid or that has been fully or partially dried onto a device. An individual can also spit into a receptacle that is transferred to the detection device or directly onto the SERS substrate itself.

In some embodiments of the example, such as in the roadside drug testing application, a transfer device is used to bring saliva from a individual to the SERS handheld device that holds the SERS substrate. The transfer device can be a cotton swap or thin plastic tube or other collection method. Alternatively, the individual can spit into a small cup or receptacle. The saliva is then inserted or otherwise moved to the handheld device. In one embodiment the cotton swab is physically rubbed across an exposed SERS substrate area. In a second embodiment of the example, the saliva is first put into a liquid or solvent, which can contain reagents, and is then placed, e.g. dropwise or rubbed, onto the SERS substrate area. To ensure repeatability and accuracy, it can be desirable to control the amount of the test substance applied to the device, for example by using an automated pipette or controlled volume pump, such as a peristaltic pump. In some embodiments the SERS substrate can be a onetime use device, e.g. on a slide, that is inserted into the handheld device prior to measurement and removed from the handheld device after measurement. In other embodiments, one SERS substrate is used for multiple tests such as where a small active area of the substrate is exposed for each measurement, then translated, via XY coordinates, to the next active area and used in a stepwise manner.

In forensic or hospital lab tests, a desktop unit can be used. The SERS substrate can be single use or multiple use. For multiple use substrates, as above, care is taken to ensure no cross-contamination. A desktop unit can have more capabilities than a smaller handheld unit. It can also have multiple laser lines, e.g. 633 nm and 785 nm, whereas a handheld unit can have only one laser line (e.g. 785 nm).

Another possible embodiment is combining the SERS device measurement for controlled substances with a personal identification or location mechanism. If an individual is required to have a home monitor and self test regularly, the device of example 2 can be used both to test for use of controlled substances and record the identity and/or location of the person taking the test. In one example a person can apply a swab or spit into a receptacle while an image or video is taken and/or geopositioning device records the person's location. Another embodiment can be a biometric reader, e.g. a fingerprint device, which simultaneously records a finger print and absorbs perspiration from the individual and tests for controlled substances in the perspiration. Further use of the personal identification method is described in greater detail below in example 3.

In some embodiments of example 2, an intermediate stage can be used where a chemical reacts with target analytes in order to form a product, e.g. a complex that is transferred to the SERS substrate for measurement—it is a means of collection of the analyte. Alternatively, the SERS substrate can be functionalized with a chemical that reacts with target analytes or a specific analyte. This technique can also be used to concentrate the target analyte molecules on the SERS substrate or section thereof. It can also be used to separate target analytes or analyte from a more complex mixture prior to SERS measurement. For example, when cocaine in saliva or water is reacted with Cobalt (II) thiocyanate it forms a cobalt-cocaine complex (where the cocaine molecules assembly around the cobalt ion) that is insoluble in water. This complex can be extracted and dissolved in chloroform, which results in a blue solution. A small volume of the blue solution can be placed dropwise onto the SERS substrate, can be washed with water or solvent (optional), allowed to dry, and measured with Raman spectroscopy.

In another embodiment, a reactant chemical, such as Cobalt (II) thiocyanate, can be added to a saliva specimen and any solid that is formed can be extracted and dissolved in a solvent, e.g. chloroform. A small amount of that solution can be transferred dropwise to the SERS substrate for measurement. A particular reaction can occur with more than one controlled substance of interest, such as a class of controlled substances. The use of SERS measurement allows for a conclusive identification of which of the class of controlled substances is present. This method can be both a collection method and a concentration method.

In a particular example, cocaine powder (0.5 mg) was dissolved in 0.5 M HCl (20 microliters), mixed with 0.5 mg Co(II) thiocyanate powder. A blue material formed which separated from the aqueous solution. This Co-cocaine precipitate was dissolved in chloroform to form a ˜200 ul blue solution, discarding the aqueous portion. 5 microliters of this was dropped onto a SERS substrate (R2) and dried, washed with 50 microliters of water, 50 ul of PBS, and dried. The surface was analyzed with a 10× objective on the Aramis™ Raman system. 785 nm excitation laser, 8.6 mW at sample, 20 sec×3 accumulations. Rotating the sample by 90 degrees reduces the intensity >10 fold.

If a dry reading is required, the drying process should not require a heating source. The amount of liquid used by these processes is minimal and the drying should occur quickly. A heating source, however, could be used. This heating source can include such features as an air-puff to dry the SERS substrate, a resistive heating source, or a thermoelectric heat source.

Once the SERS measurement has been performed, the output SERS signal from either the handheld unit or desktop unit is processed using software. An example of such software includes chemometric software, or any other software for analyzing Raman spectra that is known in the art. Using this software the system is able to resolve specific chemicals even in complex mixtures.

As described above, the SERS substrate can be made utilizing wafer scale processing that significantly improves upon currently available methods. The manufacturing process provides control over key parameters, optimized geometries for SERS and the analyte molecules to be detected, long shelf-life products, flexibility, and optimization of known SERS enhancement factors. Furthermore, the resulting devices are not dependent on random or inconsistent effects often seen in other SERS systems. The manufacturing process is cost effective and produces high quantity devices.

As described above, the controlled substances application of the SERS substrate can be used for roadside drug testing, indication of drug impairment, indication of driving under the influence, detection of illegal drug use, detection of controlled substances, and forensic lab identification of chemicals. The sensitivity levels are better in the SERS substrate method than the noted prior art. This provides the controlled substance SERS substrate detection with several important advantages over the prior art. Furthermore, some prior art devices require immunoreagent detection which uses fragile reagents that form a sandwich around the analyte. The immunoreagent detection limits the types of simultaneous analytes that can be detected.

Furthermore, not all analytes have strong-binding reagents, resulting in reduced sensitivity. Accordingly, the inventive subject matter provides improvements over the prior art, including, but not limited to: allowing for simultaneous measurement of multiple Raman detectable chemicals, reproducibility, wafer scale production, reliability, consistency, high levels of sensitivity, control over key parameters, optimized geometries for SERS and the analyte molecules to be detected, long shelf-life, passivation layer as anchor for chemical functionalization as needed, flexibility, known SERS enhancement factors, no dependence on random or inconsistent effects often seen in other SERS substrate systems, transparent substrates that can be used allowing SERS excitation from both front or back surface, and compatibility with most Raman spectrometers, including portable Raman equipment.

In most embodiments of example 2, the handheld device is likely a single band device for simplicity, using for example, a 785 nm diode laser. However, it could have multiple lasers, such as 785 nm and 633 nm. Other wavelengths can also be generated, for example by using a frequency doubling crystal with one of the lasers described above. In other embodiments, the handheld device can also be used with a tunable source. These options depend upon the application and the analytes that are targeted. A desktop unit, such as in a clinic or forensic lab, would likely include multiple lasers and/or have a tunable source.

The chance for false positives is relatively low due to the unique signature given by SERS. False negatives, where other materials, e.g. in the saliva, populate all of the “active areas” and the target chemicals can't find the active area to attach to can be reduced by functionalizing the SERS device or by using derivitization methods to make the device more selective to target analytes and/or provide greater blocking of unwanted/unneeded binding of other molecules to the active areas.

The SERS spectrum can reveal many molecules, including target analytes and other materials in the saliva. Software can used to determine what analytes are sufficiently resolved at a sufficient signal to noise ratio. The band of the SERS spectrum that is used in the measurement can be tuned to the wavelength band of interest for certain target analytes if desired.

The process can also include a background test of the SERS device prior to application of any material, to ensure that if a material is identified, it was not in the test area prior to application of the test material, e.g. saliva. The device itself can be tested with “test” or calibration slides, such as a common analyte, e.g. Rhodamine 6G (a dye) can be used to verify/calibrate the device before using it on a test substance.

The device can be more qualitative than quantitative, and reveal presence of analyte, e.g. cocaine, rather than an exact amount. Certain analytes can be easier to identify than others if they bind to the active area better and if they are more “SERS active”.

Finally, testing does not destroy the sample as relatively low-fluence lasers are used in the SERS process. Additionally, the laser spot size is generally much less than the area that can be tested, i.e. sample coated SERS active area on device, therefore in the unlikely event that the first tests modified the test area, there are many more areas that would be available for test to confirm previous results and be used for future determinations. Thus, for forensic purposes, the slide can be stored, after the initial test has been run, for future use as evidence.

### EXAMPLE #3

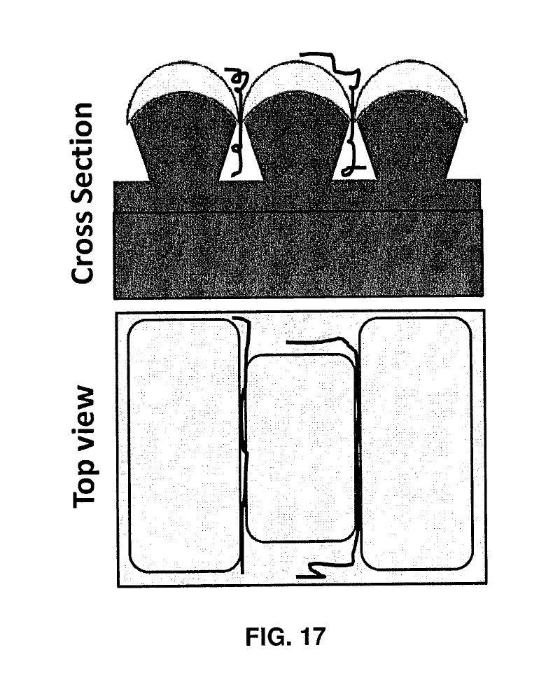

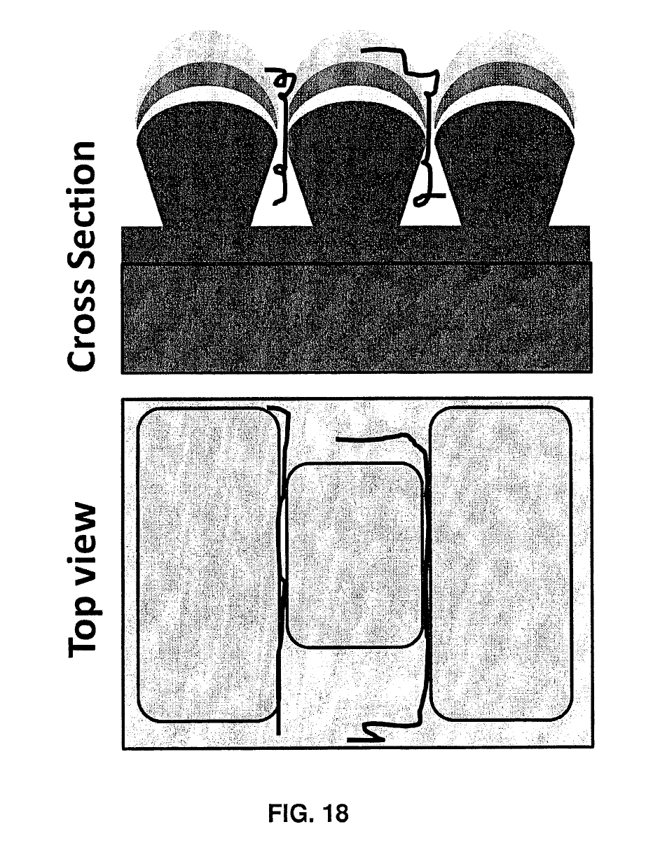

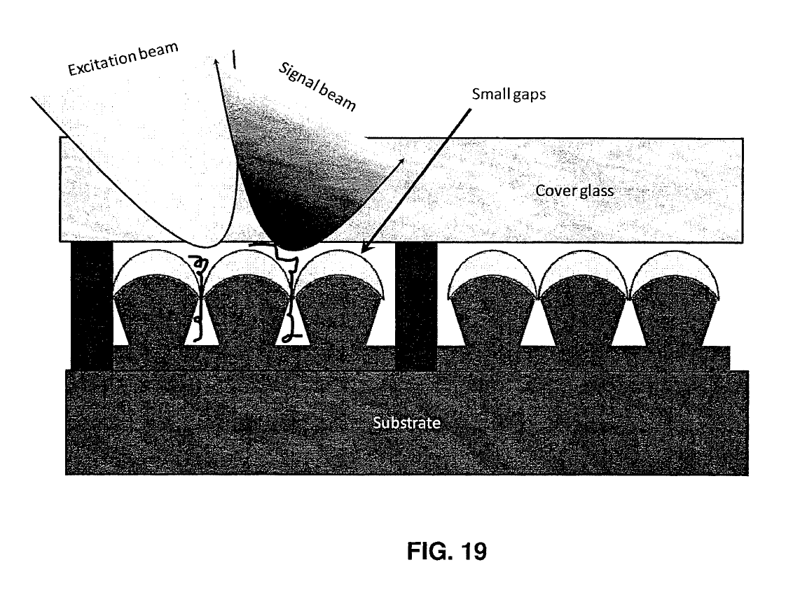

A third example use for the plasmonic structure described above concerns it's use for DNA sequencing. One method for performing DNA analysis is described in an article by R. H. Austin et al. entitled “Scanning the Controls: Genomics and Nanotechnology,” IEEE Trans. Nanotech. vol. 1 no. 1 March 2002. The system described in this article detects green fluorescent proteins, which are tags on the DNA. The system also uses narrow channels to straighten out the DNA molecules. The fluorescent proteins are excited by back illuminating a stretched DNA sample through a narrow slit. The DNA molecule moves passes through narrow channels, on the order of 100 nm wide, transverse to the evanescent field. The Plasmonic structure described above has channels on the same order as the channels in the Austin article. FIGS. 17 and 18 illustrate strands of DNA being drawn through the plasmonic structure. Once the DNA strands have been drawn into the nano-channels, a cover glass can be placed overtop of the DNA strands to form chambers for spectroscopic detection as shown in FIG. 19. Once these chambers have been form, spectroscopic detection can take place by applying a laser beam, through a narrow slit, transverse to the stretched DNA molecules in the slots of the plasmonic substrate, and monitoring the SERS emissions from the molecules. Alternatively, the spectroscopic detection can scan a narrow, highly columnated laser beam along the DNA sample in the substrate, recording the SERS emissions as each segment is scanned. This spectroscopy can then compared to an existing database to identify the illuminated DNA segment, These segments can be used for DNA sequencing, for example, to identify an individual from a DNA sample.

### EXAMPLE #4

A fourth example of use for the SERS substrates described herein can be for refractive index sensing. SPR and LSPR are typically used to identify substances based on their index of refraction. SPR and LSPR Apparatus for sensing biologicals and chemicals is described in an article by M. Svedendahl et al. entitled “Refractomertic Sensing Using Propagating versus Localized Surface Plasmons: A Direct Comparison,” Nano Let., 2009 vol. 9, no. 12, pp 4428-4433. The apparatus disclosed in this article uses gold nano-rings to sense refractive index shifts caused by various biologic nanoparticles. The plasmonic structure described above is suitable for sensing refractive index shifts as it has very good index sensitivity to liquids and is relatively insensitive to the angle of incidence (AOI) of the laser beam.

The angle of incidence (AOI) insensitive performance of the LT samples is illustrated in FIG. 20, which shows strong absorption of the laser light for several AOI from 45 degrees to 80 degrees when P-polarized light is used to illuminate the plasmonic structure.

Using these techniques, the plasmonic structure exhibits a normalized sensitivity of approximately 530 nm/RIU (refractive index units) where traditional sensitivity of SPR or LSPR techniques is on the order of 330 nm/RIU. In this example, the nano-channels in plasmonic structure naturally attach/attract small particles/liquid so the attaching speed can improve as well.

The plasmonic structure and sensing methods of this example have several advantages over the prior art, including a simpler setup than the SPR devices, e.g. less concern for AOI accuracy. The device described in this example can be implemented as a portable device for a variety of tasks such as environmental monitoring, point of care diagnostics, and explosive detection. In addition, this device can employ simpler, more straightforward transmission and/or reflection, compared to SPR, which excites the substrate through a prism. In addition, the increased surface textures of the plasmonic structure can be tuned for increased affinity of molecules.

More information about the index-sensing technique is contained in an article by X. Deng et al. entitled “Single-Order, Subwavelength Resonant Nanograting as a Uniformly Hot Substrate for Surface-Enhanced Raman Spectroscopy,” Nano Lett. 2010, 10 (5), pp 1780-1786. DOI: 10.1021/nl1003587. This reference is herein incorporated by reference. More information can also be found in an article by M. Svendendahl et al., entitled “Refractometric Sensing Using Propagating versus Localized Surface Plasmons: A Direct Comparison” Nano Lett., 2009, 9 (12), pp 4428-4433; DOI: 10.1021/nl902721z.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for manufacturing a surface enhanced Raman spectroscopy (SERS) active structure on a substrate, said method comprising:
applying a photoresist layer to the substrate;
performing lithography;
etching the substrate based on the exposure pattern to produce a plurality of nanostructure cores having a plurality of sides extending from the substrate, adjacent nanostructure cores being separated by respective core gaps;
depositing an intermediate material onto the plurality of nanostructure cores by a plasma enhanced chemical vapor deposition; and
depositing a SERS active material onto the intermediate material wherein the structure with the SERS active material includes SERS gaps corresponding to the core gaps, the SERS gaps having a size sufficient to be effective in a SERS process.

2. The method of claim 1 further comprising:
depositing an adhesion material onto the intermediate material; and
depositing a SERS active material onto the adhesion material wherein the structure with the SERS active material includes SERS gaps corresponding to the core gaps, the SERS gaps having a size sufficient to be effective in a SERS process.

3. The method of claim 1 further comprising altering the surface roughness of the SERS active material.

4. The method of claim 3 further comprising electromechanically altering the surface roughness of the SERS active material.

5. The method of claim 3 further comprising smoothing the surface of the SERS active material.

6. The method of claim 3 further comprising roughening the surface of the SERS active material.

7. A surface enhanced Raman spectroscopy (SERS) system comprising:
a substrate including a first material;
a plurality of nanostructures extending from the substrate, each of the plurality of nanostructures comprising:
a core monolithic with the substrate,
a dome shaped coating of intermediate material covering at least a portion of the core, and
a coating of a SERS active material having a substantially uniform thickness; and
wherein the plurality of cores are separated from each other by core gaps and the SERS active material on adjacent cores is separated by SERS gaps, the SERS gaps having a size sufficient to be effective in a SERS process.

8. The system of claim 7 wherein the core gaps are a uniform distance apart.

9. The system of claim 7 wherein the core gaps are a non-uniform distance apart.

10. The system of claim 7 wherein the plurality of nanostructures extending from the substrate are arranged in a one-dimensional pattern.

11. The system of claim 7 wherein the plurality of nanostructures extending from the substrate are arrange in a two-dimensional pattern.

12. The system of claim 7 wherein the plurality of nanostructures extending from the substrate are comprised of the first material.

13. The system of claim 7 wherein the plurality of nanostructures extending from the substrate are comprised of a second material.

14. A method for manufacturing a surface enhanced Raman spectroscopy (SERS) active structure on a substrate, said method comprising the steps of:
applying a photoresist layer to the substrate;
performing lithography;
etching the substrate based on the exposure pattern to produce a plurality of nanostructure cores having a plurality of sides extending from the substrate, adjacent nanostructure cores being separated by respective core gaps;
depositing an intermediate material to onto the plurality of nanostructure cores;
etching the intermediate material to form a plurality of grooved structures; and
depositing a SERS active material onto the etched intermediate material.

15. The method of claim 14 further comprising:
depositing an adhesion material onto the intermediate material; and
depositing a SERS active material onto the adhesion material wherein the structure with the SERS active material includes SERS gaps corresponding to the core gaps, the SERS gaps having a size sufficient to be effective in a SERS process.

16. The method of claim 14 further comprising altering the surface roughness of the SERS active material.

17. The method of claim 14 further comprising electromechanically altering the surface roughness of the SERS active material.

18. The method of claim 14 further comprising smoothing the surface of the SERS active material.

19. The method of claim 14 further comprising roughening the surface of the SERS active material.

20. The method of claim 14 wherein etching the intermediate material to form a plurality of V-shaped grooved structures.

21. The method of claim 14 wherein etching the intermediate material to form a plurality of U-shaped grooved structures.

22. The method of claim 14 wherein etching the intermediate material to form a plurality of parabolic-shaped grooved structures.

23. A surface enhanced Raman spectroscopy (SERS) system comprising:
a substrate including a first material;
a plurality of nanostructures extending from the substrate, each of the plurality of nanostructures comprising:
a core monolithic with the substrate,
a coating of intermediate material covering at least a portion of the core, and
a coating of SERS active material covering at least a portion of the intermediate material; and
wherein the coating of intermediate material on the nanostructures forms a plurality of grooved structures.

24. The system of claim 23 wherein the core gaps are a uniform distance apart.

25. The system of claim 23 wherein the core gaps are a non-uniform distance apart.

26. The system of claim 23 wherein the plurality of nanostructures extending from the substrate are arranged in a one-dimensional pattern.

27. The system of claim 23 wherein the plurality of nanostructures extending from the substrate are arrange in a two-dimensional pattern.

28. The system of claim 23 wherein the plurality of nanostructures extending from the substrate are comprised of the first material.

29. The system of claim 23 wherein the plurality of nanostructures extending from the substrate are comprised of a second material.

30. The system of claim 23 wherein the plurality of nanostructures extending form the substrate are a plurality of nanostructure cores.

31. The system of claim 23 wherein the coating of the intermediate material forms a plurality of V-shaped grooved structures.

32. The system of claim 23 wherein the coating of the intermediate material forms a plurality of U-shaped grooved structures.

33. The system of claim 23 wherein the coating of the intermediate material forms a plurality of parabolic-shaped grooved structures.

34. A grating with small gaps in the range of 1-50 nm, which absorbs >95% of the optimal incident laser beam close to surface normal incidence, where the said structure do not produce noticeable diffraction for the incidence.

35. The said structure of claim 34 absorbs >90% of incident laser beam no less than +/−15 deg of angle of incidence (AOI).

36. The said structure of claim 34 absorbs >90% of incident laser beam no less than +/−30 deg of angle of incidence (AOI).

37. The said structure of claim 34 absorbs >90% of incident laser beam no less than +/−60 deg of angle of incidence (AOI).

38. The said structure of claim 34 absorbs >50% of incident laser beam no less than +/−80 deg of angle of incidence (AOI).

39. The said structure of claim 34 absorbs >90% of incident beam within +/−10 nm of the optimal center spectral position at surface normal incidence.

40. The said structure of claim 34 absorbs >90% of incident beam within +/−25 nm of the optimal center spectral position at surface normal incidence.

41. The said structure of claim 34 absorbs >70% of incident beam within +/−50 nm of the optimal center spectral position at surface normal incidence.

42. The said structure of claim 34 absorbs >50% of incident beam within +/−50 nm of the optimal center spectral position and over +/−15 deg. AOI for optimal polarization.

43. A grating with small gaps in the range of 1-50 nm, which reflects <5% of the optimal incident laser beam close to surface normal incidence, where the said structure do not produce noticeable diffraction for the incidence.

44. The said structure of claim 43 reflects <50% of incident beam within +/−50 nm of the optimal center spectral position and over +/−15 deg. AOI for optimal polarization.

45. A grating with small gaps in the range of 1-50 nm, which has a reflectivity within R0+/−5%, R0 being the optimal reflectivity of the incident laser beam close to surface normal incidence, when spectral range varied +/−20 nm, where the said structure do not produce noticeable diffraction for the incidence.

46. A grating with or without small gaps, where the said structure do not produce noticeable diffraction for the incidence, when used in a detection device or system, generates significant (>10 times) difference in detection signal when the polarization orientation or properties of the incident excitation changes.

47. The said device and/or system of claim 46 generates >50 times difference in detection signal when the polarization orientation or properties of the incident excitation changes.

48. The said device and/or system of claim 46 generates >100 times difference in detection signal when the polarization orientation or properties of the incident excitation changes.

49. An airborne analyte detector utilizing the SERS substrate of claim 1.

50. A handheld roadside controlled substance detector utilizing the SERS substrate of claim 1.

51. A DNA detection and genome sequencing device utilizing the SERS substrate of claim 1.
